(19) United States
(12) Patent Application Publication
(10) Pub. No.: US 2009/0039017 A1
(43) Pub. Date: Feb. 12, 2009

(54) Packing for a Bioreactor

(76) Inventor: Heinrich Uphoff, Aschau i. Chmg. (DE)

Correspondence Address: OLIFF & BERRIDGE, PLC, P.O. BOX 320850, ALEXANDRIA, VA, 22320-4850, US

(21) Appl. No.: 11/667,161

(22) PCT Filed: Oct. 17, 2005
(86) PCT No.: PCT/DE05/01847

§ 371 Date: Mar. 12, 2008

(30) Foreign Application Priority Data
Nov. 15, 2004 (DE) 10 2004 055 056.5

(51) Int. Cl. C02F 3/00

(52) U.S. Cl. 210/617; 210/615

(57) ABSTRACT

There is disclosed a packing for a bioreactor in a small sewage treatment works for the degradation of organic and/or inorganic pollutants in effluent water. Said packing comprises an enlarged surface, achieved by the use of a special paper. Said paper is folded and arranged in concentric rings around an active charcoal filter. The paper itself has a layered embodiment made from, for instance, a silicone, a cellulose and an aluminum layer. A microbial mixture is then introduced into the cellulose layer, in particular with a proportion of photo-synthetically acting and a proportion of light-emitting microorganisms, permitting a degradation of the organic/inorganic pollutants in the effluent water.

The invention relates to a packing for a bioreactor according to claim 1, a bioreactor comprising a packing of this type according to claim 21, a sewage treatment plant comprising a bioreactor of this type according to claim 27 as well as a paper for a packing of this type according to claim 29.

If the municipal or local authorities cannot provide the owner of a property with a separate connection to an outfall sewer, as a rule he/she has to establish a small sewage treatment works, when the duty of effluent water disposal has been imposed on him/her. Small sewage treatment works of this type including a fully biological stage are established within the piece of land to be drained and generally serve for treating the domestic waste water. The treated effluent is either percolated after passing the small sewage treatment works—as far as the underground is sufficiently absorbent—or is guided to the next open waters.

For mechanical purification of the waste water frequently multi-chamber settling pits are used in which the non-dissolved substances are removed from the effluent water by settling to the ground or by floating to the surface. Multi-chamber settling pits can be in the form of dual-chamber or triple-chamber pits, for instance, wherein such chambers are formed in a common vessel and are interconnected such that the water can flow through the chambers without the settled or floated non-dissolved substances.

Especially older buildings and properties often have such multi-chamber settling pits the purifying performance of which usually does not satisfy the legal provisions, however. By virtue of the high investment costs for the construction of new small sewage treatment works with a mechanical and biological separation stage it is frequently preferred to retrofit the existing multi-chamber systems with a biological stage.

The reliable degradation of organic pollutants in effluent water, waste air or in solid substances, for instance contaminated construction material, in the pore system of which oil residues caused by leaking fuel oil had collected during former floods, constitutes a substantial requirement to modern waste recovery systems.

In the documents DE 100 62 812 A1 and DE 101 49 20 447 A1 it is suggested to degrade these undesired organic components in fluids and solids by a microbial mixture that contains a proportion of photo-synthetically acting microorganisms and a proportion of light-emitting microorganisms. This mixed culture was successfully employed in the purification of municipal and industrial effluent water as well as in cleaning up construction material contaminated with oil residues.

In the post-published patent application DE 102 53 334 the microbial mixed culture is further developed by the fact that it is modified such that during the degrading process photo-sensitizers are deposited in the cells of the organic pollutants and singlet oxygen or other radicals which accelerate the degradation of the organic components are formed by excitation of said photo-sensitizers.

In the post-published patent application DE 103 30 959.4 a bioreactor is shown in which a packing having a catalytically active surface is applied in a vessel. The tubular vessel is provided with a plurality of breakthroughs on which a photo-catalytically active layer is applied in the form of strips. It turns out that this bioreactor, also referred to as optoreactor, permits a particularly efficient sewage treatment.

In the post-published patent application DE 10 2004 046693.9 a bioreactor is disclosed which permits an enhanced degradation of the organic pollutants due to a diamond coating applied to the vessel wall between the photo-catalytic layer.

It is a drawback of the existing bioreactors, however, that effluent water contaminated with drugs, for instance, cannot be purified.

Therefore, it is the object of the present invention to provide a possibility that ensures an even better purification of contaminated effluent water.

This object is achieved by a packing for a bioreactor according to claim 1, a bioreactor according to claim 21, a sewage treatment works according to claim 27 and a paper according to claim 29.

In accordance with the invention, a packing for a bioreactor is suggested into which microorganisms for degrading the pollutants are introduced. Said microorganisms are settled as biofilm on the surface of the packing and degrade the pollutants existing in the effluent water with the aid of interaction between light-emitting bacteria and photo-synthetically acting microorganisms. For an especially efficient purification taking place, an enlargement of the surface and thus of the active biofilm is advantageous. This can be achieved, as already suggested, by a large pore volume of the packing—for instance by the use of foamed material. A larger surface and an even better settling of the microorganisms is achieved, according to the invention, by the use of paper, wherein the structure of the paper according to the invention contributes to a better formation of the biofilm and thus to an enhanced degradation of the pollutants so that even drug residues existing in the effluent water can be removed.

It is especially advantageous to fold the paper and thus to enlarge the surface.

Furthermore it is of advantage to use a paper consisting of at least two layers, wherein the one layer particularly promotes the settling of microorganisms. It has turned out that the use of silicone paper especially exhibiting on the one side a silicone coating and on the other side a coating of aluminum, a semiconductor material/semi-conducting polymer or a diamond material is particularly suited.

The use of high-density polyethylene is of particular advantage. It increases the stability of the paper and thus ensures that the folding of the paper is maintained even with high cross-flow rates.

In another advantageous embodiment the layers are connected to each other by hot melt adhesive film, especially by an epoxy adhesive. This guarantees a particularly good connection of the layers without impairing the growth of the microorganisms.

A packing according to the invention in which the paper comprises an additional layer of cellulose or a fibrous mat is especially advantageous. In said cellulose or general fibrous material layer a biofilm can be especially efficiently formed and thus the efficiency of the bioreactor can be further increased.

In accordance with the invention, another especially preferred packing has at least one recess which, in a further advantageous embodiment, reaches to the hot melt adhesive film layer. In this way, the contact of the microorganisms is even further enhanced and the effluent water can penetrate the paper so that the pollutants can be degraded by the microorganisms.

In another advantageous embodiment the packing has a circular cross-section, because it is especially cylindrical or funnel-shaped. In this way, the water to be purified can penetrate the bioreactor especially well.

A particularly efficient purification is given with a packing according to the invention in which the paper is arranged in annular shape. Furthermore, it is then advantageous to arrange the paper around an active charcoal filter. The active charcoal filter acts as a catalyst for the biofilm, whereby an even better purification of the effluent water is obtained.

As another advantageous embodiment of the packing shows, even several paper rings including active charcoal filters arranged therebetween can be provided. This further enlarges the surface on which the biofilm settles, thereby in turn the efficiency of a bioreactor containing the packing being increased.

In another preferred embodiment the active charcoal filter is additionally coated with a photo-catalytic layer, especially with titanium dioxide and/or indium tin oxide. Said photo-catalytic layer assists the interaction between photo-synthetically acting microorganisms and light-emitting bacteria, whereby enhanced effluent water purification is obtained.

According to the invention, an especially good result is achieved, when the active charcoal filter is coated on the surface facing the paper, because then the catalytic effect is particularly great.

In a further advantageous embodiment moreover a support ring is provided for supporting the active charcoal filters and the paper rings. This ensures that the packing remains stable even at higher cross-flow rates and maintains its shape.

An embodiment in which the packing is employed in a bioreactor for a small sewage treatment works is especially preferred, wherein the packing is accommodated by a vessel having at least one port through which the effluent water to be treated can flow in.

It is especially advantageous for the purification of the effluent water when a photo-catalytic layer, for instance of titanium oxide or indium tin oxide, is applied to the inner circumferential face and/or the outer circumferential face of the vessel. It is particularly preferred in this context when the photo-catalytic layer is applied to the outer circumferential face in the form of strips, wherein said strips may extend in the longitudinal direction of the bioreactor—i.e. with a cylindrical bioreactor said strips extend in parallel to the longitudinal axis.

The recesses of the container are preferably formed by punching, the punching burrs extending inwardly into the encompassed interior of the bioreactor. By said comparatively sharp burrs defects in the coating are formed at which preferably a biofilm is formed during operation.

The vessel may be cylindrical having an end face open from the bottom or funnel-shaped. In the latter case the side walls of the downwardly tapered vessel are provided with recesses for the effluent water, while the lower end face is closed. That is to say, in the latter case the cross-flow takes place approximately in radial direction, whereas in the former case a cross-flow takes place in axial direction from the bottom to the top.

In accordance with the invention, microorganisms are introduced into the packing for the degradation of the pollutants. In a preferred solution the microorganisms are bound in chitosane or a biopolymer and the packing is impregnated with said mixture. The microbial mixture may further contain, apart from the light-emitting and photo-synthetically acting microorganisms, a share of nano-composite materials having a preferably piezoelectric core the surface of which is provided with a photo-catalytically active layer. In a preferred embodiment, said nano-composite material shows a fibrous structure having a length of from 20 to 100 nm and a diameter of from 2 to 10 nm.

In accordance with the invention, a sewage treatment works, especially a small sewage treatment works comprising a bioreactor according to the invention which contains a packing according to the invention is especially advantageous, because the effluent water is efficiently purified and also retrofitting of an already existing sewage treatment works is possible without difficulty.

In another preferred embodiment the bioreactor according to the invention is arranged downstream of a standard bioreactor. Thus, a particularly efficient purification of polluted effluent water is possible.

Further preferred embodiments and advantageous further developments are defined in the subclaims.

Hereinafter the invention will be illustrated in detail by way of schematic drawings, in which:

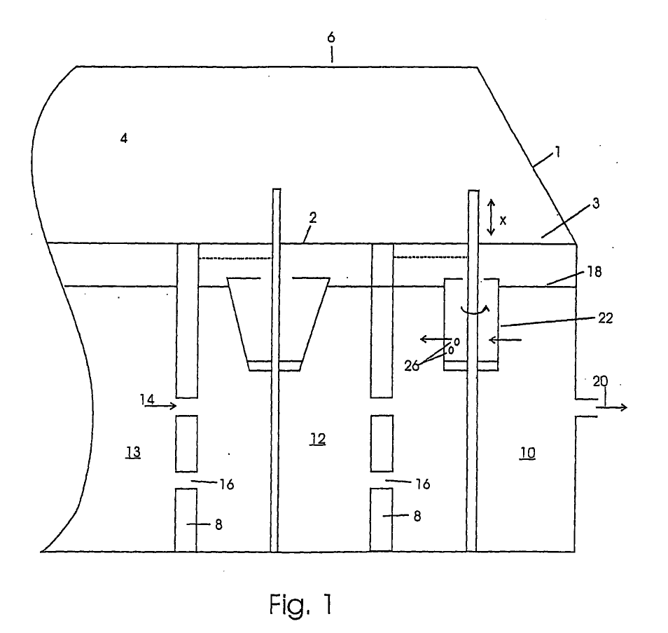

FIG. 1 is a schematic diagram of a multi-chamber sewage treatment works having a biological stage arranged downstream thereof;

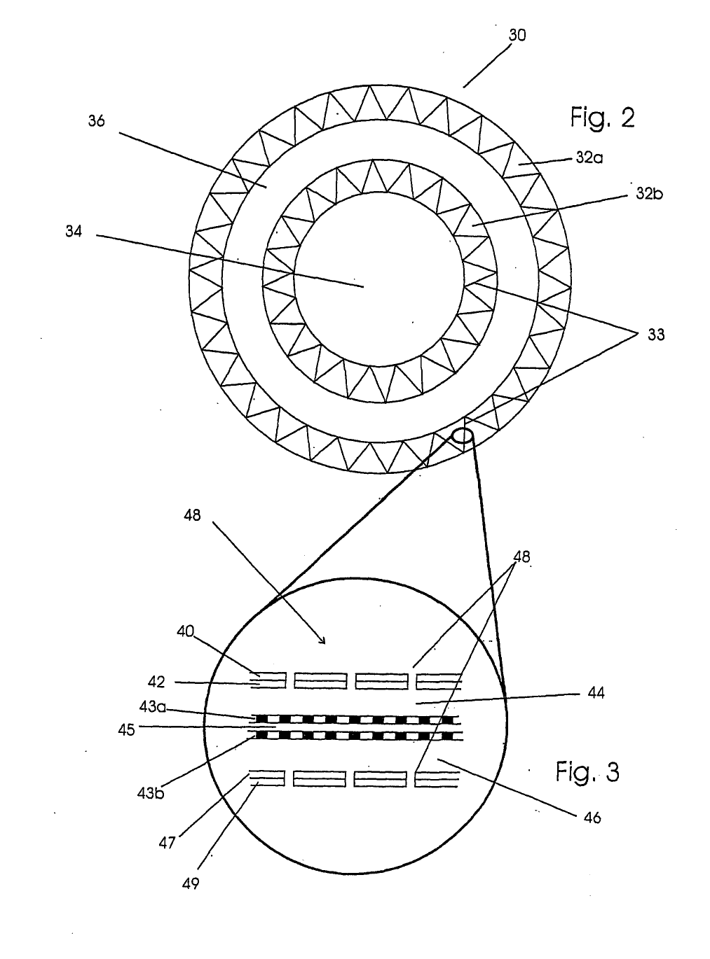

FIG. 2 is a schematic representation of the packing according to the invention in cross-section;

FIG. 3 shows an enlarged representation of the silicone paper according to the invention;

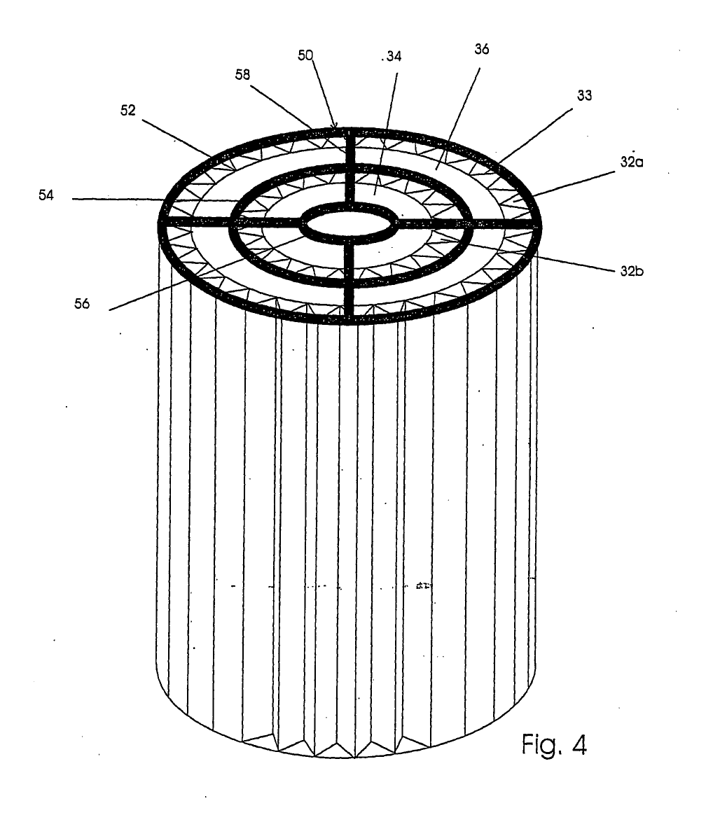

FIG. 4 is a schematic representation of the packing according to the invention in accordance with FIG. 2 in a spatial side view.

FIG. 1 shows a section across a small sewage treatment works 1 including a mechanical stage formed by a multi-chamber settling pit 4. Multi-chamber settling pits of this type are still found on a plurality of properties—especially in rural areas. Basically this is a vessel 6 subdivided by a partition 8 into three or more partial chambers of which a first chamber 10 and two further chambers 12 and 13 are shown in FIG. 1. The effluent water to be purified flows to the multi-chamber settling pit through an inflow 14 and enters into a first chamber—not shown—and can flow off through passages 16 provided in the wall 8 into the next partial chamber 13 and from there into the partial chambers 12 and 10. In the individual chambers 10, 12 settleable substances settle by sedimentation, whereas floating material floats on the surface 18 of the liquid. The outflow 20 is selected such that the sediments and the floating material remain in the chambers 10, 12 and the purified effluent water is discharged without said impurities.

For biological preparation the bioreactor 2 representing a biological stage is provided in the chamber 10 as retrofit kit. In addition, as shown in FIG. 1, another chamber 12 can be equipped with a bioreactor 3 which is arranged upstream of the bioreactor 2 according to the invention. Such conventional bioreactors 3 are described in detail in patent applications of the applicant PCT/DE2004/001491 and DE 10 2004 046693.9 which herewith are referred to.

The main part of the bioreactor 2 according to the invention is a vessel or screen basket 22 which is in the form of a float in the shown embodiment, i.e. it has enough buoyancy to float in the effluent water to be biologically treated. For positioning the screen basket 22 in the chamber 10 a vertical guide 24 is arranged which can be supported, for instance, at the partition 8 and/or the side walls of the triple-chamber settling pit 6 (cf. broken lines in FIG. 1). The screen basket 22 is movably arranged along said vertical guide 24 in the X-direction in FIG. 1 so that it is movable upwards or downwards as float inside the chamber 10 depending on the liquid level 18.

Catalytically acting surfaces by which a particular microbial mixture forms a biofilm are introduced into the screen basket 22. In the shown embodiment, said microbial mixture consists of a share of photo-synthetically acting microorganisms and a share of light-emitting microorganisms. The interaction between the photo-synthetically working microorganisms and the luminous bacteria entails that the photo-synthetically working microorganisms are excited to photosynthesis by the emitted light. The microorganisms run the photosynthesis with hydrogen sulfide and water as educt and release sulfur and/or oxygen. Furthermore they can bind nitrogen as well as phosphate and degrade organic as well as inorganic material. As regards the concrete composition of said microbial mixed culture, to simplify matters, it is referred to the patent applications DE 100 62 812 A1 and DE 101 49 447 A1 of the applicant. With reference to this application, after describing the embodiments only the substantial steps of said photodynamic degradation will be illustrated.

By interaction of the microbial mixture and the catalytic surfaces of the screen basket 22 a photodynamic degradation of organic substances takes place. Said photodynamic degradation of substances is described, for instance, in the application DE 102 53 334 of the applicant.

The structure of the screen basket 22 shall be illustrated hereinafter. In the shown embodiment the screen basket 22 has an approximately cylindrical geometry in the side view. The side walls of the screen basket 22 are made of stainless steel in the shown embodiment and can be provided at least partly with a photo-catalytically acting coating. Said coating can be formed at the inner circumferential wall of the screen basket 22 and/or at the outer circumferential wall. In the represented embodiment the screen basket 22 is made of V4A and is provided with a titanium dioxide coating. Instead of titanium dioxide, also indium tin oxide or the like can be used.

The outer circumferential wall of the screen basket 22 is provided with a plurality of breakthroughs 26 so that the effluent water to be biologically stabilized is capable of flowing from the chamber 10 into the interior of the screen basket 22. The lower end face 28 of the screen basket is closed so that the inflow to the screen basket 22 substantially takes place in the radial direction. The upper end face can equally be closed. In the event that said upper surface is above the liquid level, closing can be dispensed with. In the interior of the screen basket 22 an exchangeable packing 30 having a circular cross-section is accommodated.

As is shown in FIG. 2, the packing 30 includes two concentric rings 32a, 32b of folded paper 33. Said rings are arranged concentrically around an active charcoal filter core 34. Moreover, between said rings 32a, 32b another ring 36 made of an active charcoal filter material is provided. To the paper 32a, 32b in turn the microbial mixture is applied which forms a further biofilm on/in the paper so that also in the packing 30 a photodynamic degradation of the pollutants takes place.

It is especially advantageous in the shown embodiment that the paper is folded. In this way, the surface for forming the biofilm is enlarged and the efficiency of the bioreactor is increased.

Another increase in efficiency can be achieved by the fact that the surfaces of the active charcoal filter 34, 36 facing the paper are coated with a photo-catalytic layer, because the latter intensifies the interaction of the microorganisms, as illustrated already. Therefore the active charcoal filters 34, 36 have a wetting with EP and a powdering with titanium oxide on the surface facing the paper rings.

In the advantageous embodiment shown in FIG. 2 a folding of the outer paper ring 32a of approx. 66.6° and a diameter of approx. 188 mm are selected. The inner ring 32b has a folding of about 61.5° and a diameter of approx. 117 mm. That means that the inner ring 32b consists of approx. 20 foldings and the outer ring 32a consists of approx. 30 foldings. For this purpose—with an advantageous length of the packing 30 of approx. 300 mm—a paper with an edge length of about 680 mm and 290 mm for the inner ring 32b and with an edge length of about 1075 mm and 290 mm for the outer ring 32a is required.

In contrast to that, for a structure without paper folding only a paper with an edge length of approx. 590 mm×290 mm would be necessary, for instance, for the outer ring 32a. Consequently, due to the folding the surface to which the microorganisms can be applied is approximately doubled.

The active charcoal filter ring 36 has a diameter of approx. 117 mm which requires a cut of the active charcoal of about 435 mm×290 mm. The active charcoal filter core 34 has a diameter of 64 mm; therefore a cut of approx. 300 mm×290 mm is required.

The silicone paper 33 according to the invention has plural layers, as is shown in FIG. 3. A HDPE (high-density polyethylene) layer 42 is disposed beneath a silicone layer 40. Beneath the HDPE layer 42 a layer of cellulose is provided for receiving the microorganisms. In the paper used here the cellulose layer 44 is followed by an intermediate layer of a HDPE double layer 43a and 43b which is glued with a hot melt adhesive film, especially an EP adhesive 45. The next layer 46 consists of a PP fiber mat into which in turn the microorganisms are introduced. Finally a double layer of internal HDPE 47 and external aluminum 49 is provided. The silicone/HDPE layer 40, 42 as well as the aluminum/HDPE layer 49, 47 have recesses 48. The recesses 48 can also reach to the hot melt adhesive layer, however.

Since the microorganisms settle both in the cellulose layer 44 and in the PP fiber mat 46, an especially large surface for the microorganisms is provided in this embodiment. By virtue of the large number of settled microorganisms the efficiency of the bioreactor is further increased.

The structure including HDPE imparts the required stability to the paper so that even in the case of high cross-flow rates the folding remains stable.

Instead of aluminum also a semiconductor material or a diamond coating can be chosen. It ensures the buildup of an electric alternating field which assists the degradation of the pollutants. As regards the buildup and the effect of the electric alternating field, it is referred to the patent application DE 10 2004 046693.9 of the applicant.

FIG. 4 shows a spatial side view of the packing 30. The folded paper rings 32a and 32b as well as the active charcoal filter ring 36 and the active charcoal filter core 34 are connected by a support ring 50. The support ring 50 guarantees the stability of the packing 30. It consists of three concentric rings 52, 54, 56 and a supporting cross 58 disposed at the innermost ring 56 and extending to the outermost ring 52. The rings 52, 54, 56 as well as the supporting cross 58 are manufactured of corrosion-resistant sheet metal of 5 mm thickness and are glued with the paper rings 32a, 32b and/or the active charcoal core/ring 34, 36 by means of epoxy foam or polyurethane foam.

The microorganisms mentioned in the beginning can either be applied to the paper of the packing 30 centrally via a dosing hose or it is also possible to apply said microorganisms with the nano composite materials to the paper already during manufacture of the packing 30. The tests have been very promising in which the microorganisms and nano composite materials are dissolved in chitosane and said mixture including the nano composite materials is then introduced—for instance by impregnating—into the packing 30 so that a continuous supply of microorganisms is not necessary and merely an exchange of the packing 30 is required at regular intervals.

The screen basket 22 is pivoted to the vertical guide 24 by means of bearings. On principle, it is also possible to pivot only the packing 30, while the screen basket 22—or rather the shell thereof—is fixedly mounted to the vertical guide 24 so that the packing 30 is rotatable with respect to the shell.

The increase in temperature and the formation of gas during the described biological degradation process and especially the formation of the electric alternating field cause a rotation of the screen basket 22 or the packing 30 by which, on the one hand, the mixing of the effluent water to be treated inside the screen basket 22 and, on the other hand, the cross-flow through the screen basket 22 are improved.

The aforementioned electric alternating field is formed in photodynamic processes and is assisted by the photo-catalytic active coating of the screen basket 22 and of the packing 30 as well as by introducing the nano structures the mode of action of which is illustrated in detail in the patent application PCT/DE2004/001491 of the applicant.

Unless the energy introduced from the biological degradation process is not sufficient to have rotate the packing 30 or the screen basket 22, a separate drive which applies an assisting torque to cause the rotation can be associated with the same.

The photodynamic degradation of the organic components is assisted by the photo-catalytic coating of the screen basket 22 and the packing 30. For this purpose, the screen basket 22 is coated both on its inner circumferential surface and on its outer circumferential surface and the active charcoal filters 34, 36 of the packing 30 are coated on their sides facing the paper with a photo-catalytically active layer, for instance titanium dioxide. Said layer is completely applied on the inner circumferential surface of the screen basket 22, i.e. on the side facing the packing 30, whereas on the outer circumferential surface the titanium dioxide is applied in the form of strips between which areas are remaining which may be provided with a diamond coating. Such diamond coating can be prepared synthetically by heating methane and hydrogen as well as a suited carrier substance, for instance, of niobium, silicon or ceramic in a vacuum chamber to temperatures of approx. up to 2000°. Then a reaction takes place in which a diamond grid forms on the carrier substance. Said coating is then applied to the outer circumferential surface of the screen basket 22 so that areas provided with a photo-catalytically active layer and with a diamond layer are juxtaposed. Said areas extend in the longitudinal direction of the screen basket 22.

Upon interaction of the catalytic coating of the screen basket 22 and the afore-described coating of the packing 30 a comparatively strong electromagnetic field is formed. The occurring potential difference is applied to the areas provided with the diamond coating which then act as diamond electrodes.

Details about the electromagnetic field occurring are disclosed in the earlier post-published applications DE 103 30 959.4 and DE 10 2004 04 6693.9 so that further explanations in this respect are dispensable.

It is another special feature of the bioreactor 2 that the circular breakthroughs 26 of the screen basket 22 are preferably formed by punching, wherein a punching burr protrudes inwardly, i.e. toward the packing 30. The afore-described photo-catalytically active coating of titanium dioxide is applied after punching out the breakthroughs 26 in this embodiment. It turned out that the coating frequently does not adhere in the area of the extremely sharp-edged punching burrs so that said burrs remain uncoated. During operation of the bioreactor 2 the biofilm preferably becomes attached to said uncoated punching burrs—i.e. these uncoated areas act as germinating zones for forming the biofilm on the inner circumferential surface of the reactor so that the conversion of the organic components is further improved.

By the biological stage according to the invention the organic part of the dry matter (TS) in the screen basket (bioreactor) can be reduced to less than 10% of the dry matter by degradation of the inhibiting substances and by the release of oxygen and energy. The reactive singlet oxygen released by the energy activation of the oxygen very efficiently oxidizes hormone residues and antibiotics, for instance. After a few seconds organic substances are converted by disintegration and are subsequently made innocuous. The biofilm on the folded paper of the packing, on the other hand, degrades the substances dissolved in the effluent water.

The bioreactor is especially efficient, when, as shown in FIG. 1, preceding effluent water purification has taken place by another bioreactor 3. The further bioreactor 3 advantageously exhibits the characteristics of the bioreactor disclosed by the applicant in the patent applications PCT/DE2004/001491 and DE 10 2004 046693.9. But any other commercial bioreactor can be employed as well.

There is disclosed a packing for a bioreactor in a small sewage treatment works for the degradation of organic and/or inorganic pollutants in effluent water. Said packing comprises an enlarged surface, achieved by the use of a special paper. Said paper is folded and arranged in concentric rings around an active charcoal filter. The paper itself has a layered embodiment made from, for instance, a silicone, a cellulose and an aluminum layer. A microbial mixture is then introduced into the cellulose layer, in particular with a proportion of photo-synthetically acting and a proportion of light-emitting microorganisms, permitting a degradation of the organic/inorganic pollutants in the effluent water.

### LIST OF REFERENCE NUMERALS

1 Small sewage treatment works
2 bioreactor (according to the invention)
3 bioreactor (conventional)
4 multi-chamber settling pit
6 vessel
8 partition wall
10 first chamber
12 further chamber
13 further chamber
14 inflow
16 passages in wall 8
18 liquid surface
20 drainage
22 screen basket
24 vertical guide
26 breakthroughs in screen basket 22
28 lower end face
30 packing
32a paper rings (outside, inside)
32b paper rings (outside, inside)
33 paper
34 active charcoal filter core
36 active charcoal filter ring
40 silicone layer
42 HDPE layer
43a HDPE layer
43b HDPE layer
44 cellulose layer
46 PP fiber mat
47 HDPE layer
48 recess
49 aluminum layer
50 support ring
52 concentric rings (outside, center, inside)
54 concentric rings (outside, center, inside)
56 concentric rings (outside, center, inside)
58 support cross

1. A packing for a bioreactor for treatment of polluted municipal or industrial effluent water or of fluids polluted with organic or inorganic pollutants, wherein
microorganisms for degradation of the pollutants are contained; and the packing has an enlarged surface;
wherein
the enlarged surface of the packing is provided by paper.

2. A packing according to claim 1, wherein
the enlarged surface is provided by at least one folding of the paper.

3. A packing according to claim 1, wherein
the paper has at least two layers.

4. A packing according to claim 3, wherein
one of the layers is silicone.

5. A packing according to claim 3, wherein
one of the layers is made of aluminum and/or of a semiconductor material/semi-conducting polymer and/or of a diamond material and/or is a piezoelectric layer.

6. A packing according to claim 3, wherein
one of the layers includes a high-density polyethylene HDPE.

7. A packing according to claim 3, wherein
the layers are glued with hot-melt adhesive film.

8. A packing according to claim 1, wherein
at least three layers are provided, and at least one of the layer includes a fibrous material.

9. A packing according to claim 8, wherein
the microorganisms are arranged in the fibrous material layer.

10. A packing according to claim 1, wherein
the paper has at least one recess.

11. A packing according to claim 7, wherein
the recess reaches to the hot-melt adhesive film.

12. A packing according to claim 1, wherein
the packing has a circular cross-section.

13. A packing according to claim 12, wherein
the packing is cylindrical or funnel-shaped.

14. A packing according to claim 12, wherein
the paper is arranged annularly, viewed in cross-section across the packing.

15. A packing according to claim 12, wherein
the paper is arranged annularly around an active charcoal filter core.

16. A packing according to claim 14, wherein
several paper rings are provided.

17. A packing according to claim 16, wherein
an active charcoal filter is arranged between the paper rings.

18. A packing according to claim 15, wherein
the active charcoal filter is coated on the surface facing the paper.

19. A packing according to claim 18, wherein
the surface of the active charcoal filter facing the paper is coated with a photo-catalytic layer.

20. A packing according to claim 1, wherein
the packing has at least one support ring.

21. A bioreactor for treatment of polluted municipal or industrial effluent water, or of fluids polluted with organic or inorganic pollutants, in particular for a small sewage treatment works, wherein
a microbial mixture is contained for degradation of pollutants, comprising a vessel having at least one port for the passage of the effluent water to be treated,
wherein
in the interior of the vessel a packing according to claim 1 is provided.

22. A bioreactor according to claim 21, wherein
the vessel wall has a photo-catalytically active layer.

23. A bioreactor according to claim 22, wherein
the photo-catalytic layer is applied to the inner circumferential surface of the vessel largely continuously and to the outer circumferential surface of the vessel in sections.

24. A bioreactor according to claim 21, wherein
the at least one port of the vessel is punched so that punching burrs are inwardly protruding and the photo-catalytic layer is applied after punching.

25. A bioreactor according to claim 21, wherein
the vessel and/or the packing is/are pivoted.

26. A bioreactor according to claim 21, wherein
the microbial mixture contains nano particles in addition to the microorganisms.

27. A small sewage treatment works comprising a bioreactor according to claim 21.

28. A small sewage treatment works according to claim 27, wherein
at least one further bioreactor is provided.

29. A paper for a packing for a bioreactor according to claim 1 having a layered structure,
wherein
the layered structure comprises:
a silicone layer;
one or more layers of high-density polyethylene;
one or more layers of fibrous material;
a hot-melt adhesive film; and
a layer of aluminum and/or a semiconductor material/semi-conducting polymer and/or a diamond material and/or a piezoelectric material.
